(19) United States
(12) Patent Application Publication
(10) Pub. No.: US 2020/0077494 A1
(43) Pub. Date: Mar. 5, 2020

(54) GROUP SETTING METHOD FOR ILLUMINATION FIXTURE, AND ILLUMINATION SYSTEM

(71) Applicant: Panasonic Intellectual Property Management Co., Ltd., Osaka (JP)

(72) Inventors: Akihiro KISHIMOTO, Osaka (JP); Yukinori UCHIDA, Osaka (JP)

(21) Appl. No.: 16/540,999

(22) Filed: Aug. 14, 2019

(30) Foreign Application Priority Data
Aug. 28, 2018 (JP) 2018-159551

(51) Int. Cl. H05B 37/02; H05B 33/08

(52) U.S. Cl. CPC H05B 37/0254; H05B 33/086; H05B 37/0272

(57) ABSTRACT

A group setting method for an illumination fixture is a method of setting each of a plurality of illumination fixtures as a group, the plurality of illumination fixtures each having a light output pattern including its own unique identification information. The method includes photographing a first illumination fixture of the plurality of illumination fixtures with a terminal device having an imaging part to identify identification information of the first illumination fixture based on a light output pattern of the first illumination fixture, subsequently photographing a second illumination fixture of the plurality of illumination fixtures with the terminal device to identify identification information of the second illumination fixture based on a light output pattern of the second illumination fixture and identifying first group information of the second illumination fixture, and next setting the first group information identified for the second illumination fixture to the first illumination fixture.

### CROSS REFERENCE TO RELATED APPLICATION

This application claims priority to Japanese Patent Application No. 2018-159551 filed on Aug. 28, 2018, which is incorporated herein by reference in its entirety including the specification, claims, drawings, and abstract.

### TECHNICAL FIELD

The present disclosure generally relates to a group setting method for an illumination fixture, and an illumination system.

### BACKGROUND

As an example of conventional illumination systems, JP 2011-238563 A discloses an illumination system including a plurality of illumination fixtures to which respective unique identification IDs are assigned, and a controller for controlling the plurality of illumination fixtures. In this illumination system, the controller assigns a location address and a group address to each of the illumination fixtures, stores the location address and the group address in association with the corresponding identification ID, and collectively controls operations of the plurality of illumination fixtures in groups based on the group addresses assigned to the respective illumination fixtures.

### SUMMARY

### Technical Problem

In the case where each of a plurality of illumination fixtures is set to a group so that the operations of the plurality of illumination fixtures are collectively controlled in groups, it is necessary to previously set each of the illumination fixtures in a group. In this case, preferably, group setting and group change for each of the plurality of illumination fixtures can be easily performed even by general users that have no expert knowledge about the illumination fixture itself and the illumination system including a plurality of illumination fixtures.

It is an advantage of the present disclosure to provide a method of setting each of illumination fixtures to a group, the method capable of easily setting each of a plurality of illumination fixtures to a group even by general users that have no expert knowledge, and an illumination system.

### Solution to Problem

A group setting method for an illumination fixture according to one aspect of the present disclosure is a method of setting each of a plurality of illumination fixtures as a group, the plurality of illumination fixtures each having a light output pattern including its own unique identification information. The method includes photographing a first illumination fixture of the plurality of illumination fixtures with a terminal device having an imaging part, and identifying identification information of the first illumination fixture based on a light output pattern of the first illumination fixture, subsequently photographing a second illumination fixture of the plurality of illumination fixtures with the terminal device, identifying identification information of the second illumination fixture based on a light output pattern of the second illumination fixture and identifying first group information of the second illumination fixture, and setting the first group information identified to the second illumination fixture to the first illumination fixture.

An illumination system according to another aspect of the present disclosure includes a plurality of illumination fixtures each having a light output pattern including its own unique identification information, an illumination control device including a database storing group information in association with the plurality of illumination fixtures, and a terminal device having an imaging part, and configured to identify identification information of an illumination fixture based on a light output pattern of the illumination fixture photographed by the imaging part and cause group information to be stored in the database in association with the identification information of the illumination fixture. The terminal device identifies the identification information of a first illumination fixture based on a light output pattern of the first illumination fixture when photographing the first illumination fixture of the plurality of illumination fixtures, subsequently identifies the identification information of a second illumination fixture based on the light output pattern of the second illumination fixture when photographing the second illumination fixture of the plurality of illumination fixtures, and identifies first group information of the second illumination fixture, and causes the first group information identified for the second illumination fixture to be stored in the database in association with the first illumination fixture.

### Advantageous Effects of Invention

According to a group setting method for an illumination fixture and an illumination system according to the present disclosure, each of a plurality of illumination fixtures can be easily set to a group even by general users that have no expert knowledge.

### BRIEF DESCRIPTION OF DRAWINGS

The figures depict one or more implementations in accordance with the present teaching, by way of example only, not by way of limitations. In the figures, like reference numerals refer to the same or similar elements.

Embodiment(s) of the present disclosure will be described based on the following figures, wherein:

FIG. 1 is an overall configuration diagram illustrating an illumination system according to one embodiment;

FIG. 2 is a table showing an example of a database for illumination control;

FIG. 3 is a flowchart illustrating group setting processes executed by a control part;

FIGS. 4A and 4B each are a schematic diagram illustrating a group setting procedure of each of a plurality of illumination fixtures;

FIG. 5 is a table showing an example in which group information is assigned to each of the illumination fixtures in a correspondence table shown in FIG. 2;

FIG. 6 is a table showing another example in which group information is assigned to each of the illumination fixtures in a correspondence table shown in FIG. 2;

FIG. 7 is a schematic diagram illustrating a room in which six illumination fixtures are set in three groups;

FIG. 8 is a diagram illustrating an operation screen in each group displayed on a smartphone;

FIG. 9 is a table showing an example of a database for illumination control in which the six illumination fixtures are set to the three groups as illustrated in FIG. 7; and

FIG. 10 is a diagram illustrating an operation screen in each scene displayed on the smartphone.

### DESCRIPTION OF EMBODIMENTS

Hereinafter, embodiments according to the present disclosure will be described in details with reference to the accompanying drawings. In the description, specific shapes, materials, numerical values, directions, and the like are exemplified for ease of understanding of the present disclosure, and can be changed appropriately in accordance with uses, purposes, specifications, and the like. Moreover, in the case where the following description includes a plurality of embodiments, modified examples, or the like, it is originally assumed that characteristic parts in the plurality of embodiments, the modified examples, or the like are appropriately combined and used.

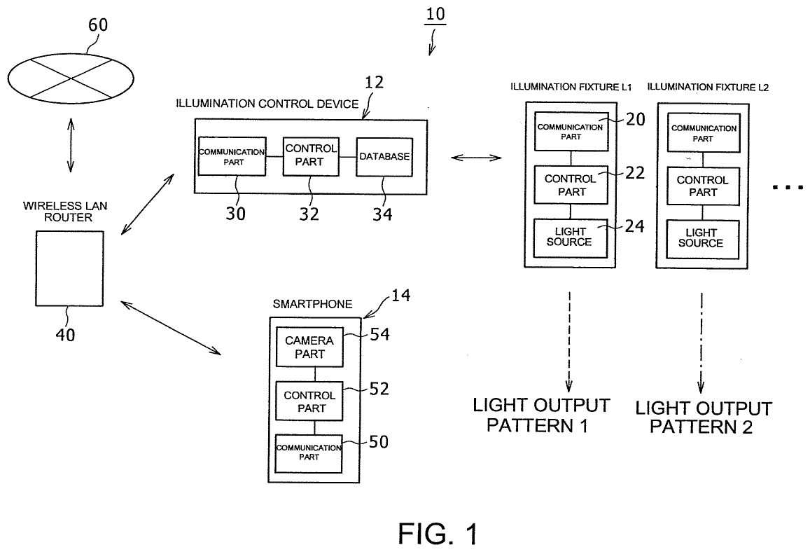

FIG. 1 is an overall configuration diagram illustrating an illumination system 10 according to one embodiment. The illumination system 10 includes a plurality of illumination fixtures L1, L2, . . . , and Ln (here, “n” is an integer of 3 or more), and an illumination control device 12, and a smartphone 14 which is an example of a terminal device.

The plurality of illumination fixtures L1, L2, . . . , and Ln are each installed on a ceiling, a wall, or the like in a room of a house, for example. Each of the illumination fixtures L1, L2, . . . , and Ln includes a communication part 20, a control part 22, and a light source 24.

The communication part 20 of each of the illumination fixtures L1, L2, . . . , and Ln has a function for performing wireless communication with an illumination control device 12. For example, Bluetooth (BlueTooth (registered trademark) is preferably used as a communication method between the communication part 20 and the illumination control device 12.

The control part 22 of each of the illumination fixtures L1, L2, . . . , and Ln has a function for controlling a lighting state of the light source 24 based on a control signal from the illumination control device 12. The lighting state of the light source 24 includes operation states such as turning on, dimming, toning, and turning off the light source 24. The light source 24 is comprised of, for example, an LED, or the like. The control part 22 controls the power supply to change the operation state of the light source 24 such as turning on, dimming, toning, or turning off the light source 24.

The control part 22 of each of the illumination fixtures L1, L2, . . . , and Ln includes a storage, and the unique identification information assigned to each of illumination fixtures L1, L2, . . . , and Ln is previously stored in its own storage. This identification information may be, for example, a serial number. The control part 22 can cause the light source 24 to flash in a light output pattern including the unique identification information. In an example illustrated in FIG. 1, the illumination fixture L1 can emit light in a light output pattern 1 including unique identification, and the illumination fixture L2 can emit light in a light output pattern 2 including unique identification. Such information communication using the light output pattern is also referred to as light ID communication, and although the light output pattern cannot be visually recognized by human eyes, a camera part (imaging part) of a smartphone 14 can photograph and analyze the light output pattern to read the information included in the light output pattern.

The illumination control device 12 includes a communication part 30, a control part 32, and a database 34 for illumination control. The communication part 30 has a function for performing wireless communication with each of the illumination fixtures L1, L2, . . . , and Ln, as described above. The communication part 30 also has a function for performing wireless communication with the smartphone 14 through a wireless LAN router 40. For example, Wi-Fi (registered trademark) is preferably used as a communication method between the wireless LAN router 40 and the illumination control device 12 or between the wireless LAN router 40 and the smartphone 14.

Note that although an example in which the illumination control device 12 communicates with the smartphone 14 through the wireless LAN router 40 is described in the present embodiment, the present disclosure is not limited thereto. The illumination control device 12 may communicate directly with the smartphone 14, and in this case, the wireless LAN router may be omitted.

The control part 32 of the illumination control device 12 can transmit the control signal to the illumination fixtures L1, L2, . . . , and Ln through the communication part 30. In this case, the control part 32 can control the lighting states of the plurality of illumination fixtures L1, L2, . . . , and Ln in groups. A method of setting each of the plurality of illumination fixtures L1, L2, . . . , and Ln to a group will be described later.

The control part 32 transmits an identification information request signal to the illumination fixtures L1, L2, . . . , and Ln through the respective communication parts 20, when receiving, from the smartphone 14, a command to collect the identification information of each of the illumination fixtures L1, L2, . . . , and Ln. When receiving this signal, each of the illumination fixtures L1, L2, . . . , and Ln transmits the signal including its own identification information to the illumination control device 12 through its own communication part 20. The control part 32 of the illumination control device 12 transmits the identification information signals received from the respective illumination fixtures L1, L2, . . . , and Ln to the smartphone 14 through the wireless LAN router 40.

The smartphone 14 is a portable terminal device that is currently widely used, and includes a communication part 50, a control part 52, and a camera part (imaging part) 54. The communication part 50 communicates with the illumination control device 12 through the wireless LAN router 40. The communication part 50 can be connected to an external communication network 60 such as the Internet, through the wireless LAN router 40. An illumination control application can be downloaded and installed on the smartphone 14 from the external communication network 60 through the communication part 50. The illumination control application is provided by, for example, a manufacturer of the illumination system 10, or the like.

Note that although an example in which the smartphone 14 is used as a terminal device is described in the present embodiment, the present disclosure is not limited thereto, and for example, a tablet, a personal computer, a dedicated remote controller, or the like may be used as the terminal device.

The control part 52 can control the lighting states of the illumination fixtures L1, L2, . . . , and Ln included in the illumination system 10, by executing the installed illumination control application, and can set each of the illumination fixtures L1, L2, . . . , and Ln to a group, as described later.

The camera part 54 has a function for photographing an image. The image photographed by the camera part 54 is transmitted to the control part 52. The control part 52 can analyze an image of each of the illumination fixtures L1, L2, . . . , and Ln that emits the illumination light including a light output pattern, and read the identification information included in the light output pattern. The identification information read by the control part 52 is stored in a storage provided in the control part 52, and is further transmitted from the communication part 50 through the wireless LAN router 40 and stored in the database 34 for illumination control of the illumination control device 12.

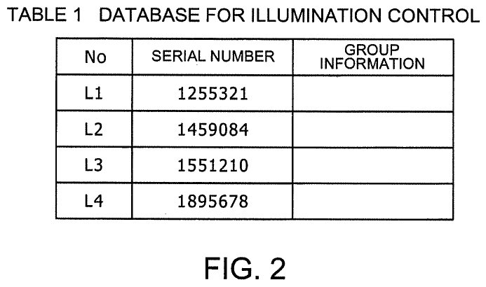

Next, the group setting operation in the illumination system 10 configured as described above will be described. FIG. 2 is a table showing an example of the database for illumination control. In the following description, a user (for example, a resident of a house, or the like) that uses the illumination system 10 can download and install the illumination control application using the smartphone 14.

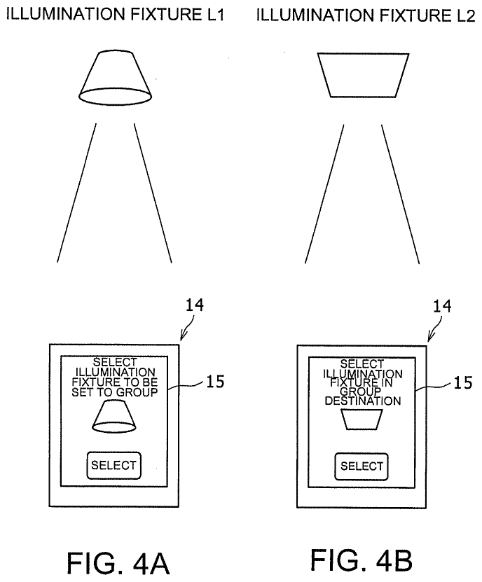

When the illumination control application is executed by the smartphone 14, an identification information collection screen (not illustrated) for collecting the identification information of the illumination fixtures L1, L2, . . . , and Ln is displayed on a display part 15 (see FIG. 4A and FIG. 4B) of the smartphone 14. The user can operate this identification information correction screen, and thereby acquire the identification information of each of the plurality of illumination fixtures L1, L2, . . . , and Ln installed in the house.

More specifically, the identification information request signal is transmitted to the illumination control device 12 from the smartphone 14 through the wireless LAN router 40, in response to user operation. The communication part 30 of the illumination control device 12 receives this identification information request signal, and then transmits the identification information request signal to each of the illumination fixtures L1, L2, . . . , and Ln.

The communication part 20 of each of the illumination fixtures L1, L2, . . . , and Ln receives the identification information request signal, and then transmits the unique identification information signal stored in the storage of the corresponding control part 22, to the illumination control device 12. The communication part 30 of the illumination control device 12 receives the identification information signals of the respective illumination fixtures L1, L2, . . . , and Ln, and then stores the received identification information signals in the database 34 for illumination control, and transmits the received identification information signals to the smartphone 14 through the wireless LAN router 40.

When the smartphone 14 receives the identification information signal from each of the illumination fixtures L1, L2, . . . , and Ln, the identification information of each of the illumination fixtures L1, L2, . . . , and Ln is displayed on the display part 15 of the smartphone 14. Here, the case where four illumination fixtures L1, L2, L3, and L4 are installed in the house is exemplified. An example in which a serial number comprised of a plurality of (here, seven) numbers is used for the identification information in this case is shown. Note that the unique identification information of each of the illumination fixtures L1, L2, . . . , and Ln is not limited to the serial number represented by numbers, and for example, may be represented by symbols such as alphabetic characters, or a combination of numbers and symbols.

As shown in FIG. 2, serial numbers of the respective illumination fixtures L1, L2, L3, and L4 are displayed on the display part 15 of the smartphone 14 in a tabular form. At this time, since each of the illumination fixtures L1, L2, L3, and L4 has not been set in a group yet, columns for group information are blank. Note that the correspondence table similar to that shown in FIG. 2 is also stored in the database 34 for illumination control of the illumination control device 12.

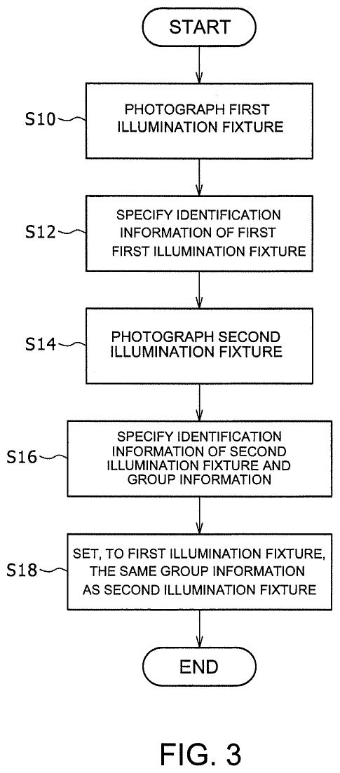

FIG. 3 is a flowchart illustrating group setting processes executed by the control part 52 of the smartphone 14. FIGS. 4A and 4B are each a schematic diagram illustrating a group setting procedure of each of the illumination fixtures L1, L2, L3, and L4.

The group setting processes shown in FIG. 3 are executed by the control part 52 of the smartphone 14 on which the illumination control application has been installed. The control part 52 photographs an image of a first illumination fixture in the lighting state in step S10. At this time, as illustrated in FIG. 4A, a screen to cause a user to select the illumination fixture to be set to a group (that is, photographed by the camera part 54) is displayed on the display part 15 of the smartphone 14. Here, the case where the illumination fixture L1 is selected as the first illumination fixture is exemplified.

When the smartphone 14 in which the camera part 54 is in the activated state is faced toward the illumination fixture L1, and a “select” button is tapped, the camera part 54 of the smartphone 14 photographs an image of the illumination fixture L1, and transmits the image to the control part 52. As illustrated in FIG. 3, in step S12, the control part 52 analyzes the image of the illumination fixture L1, and identifies unique identification information (e.g., a serial number in the present embodiment) assigned to the illumination fixture L1 based on a light output pattern 1 included in the illumination light.

Subsequently, in step S14, the control part 52 photographs an image of a second illumination fixture in the lighting state. At this time, as illustrated in FIG. 4B, for example, “select an illumination fixture in the group destination” is displayed on the display part 15 of the smartphone 14, to cause the user to select a group to which the illumination fixture L1 previously photographed is to be set. Here, the case where the user wishes to set the illumination fixture L1 previously photographed to the same group as the next selected illumination fixture L2 is exemplified.

When the smartphone 14 in which the camera part 54 is in the activated state is faced toward the illumination fixture L2, and a “select” button is tapped, the camera part 54 of the smartphone 14 photographs an image of the illumination fixture L2, and transmits the image to the control part 52. As illustrated in FIG. 3, in step S16, the control part 52 analyzes the image of the illumination fixture L2, and identifies unique identification information (a serial number in the present embodiment) assigned to the illumination fixture L2 as the second illumination fixture based on a light output pattern 2 included in the illumination light, and the group information.

More specifically, the control part 52 can identify the serial number of the illumination fixture L2 by analyzing the light output pattern 2 of the illumination fixture L2. Also, the control part 52 identifies the group information of the illumination fixture L2 with reference to the correspondence table stored in the storage of the control part 52 based on the serial number acquired by analyzing the light output pattern 2. In this case, as shown in FIG. 2, since the group information of the illumination fixture L2 has not been set yet or has not been registered yet, the control part 52 assigns, for example, first group information “A” as unused group information to the illumination fixture L2. Note that the group information is not limited to alphabetic characters, and may be represented by numbers, symbols, or a combination of numbers and symbols.

Subsequently, in step S18, the control part 52 sets, to the first illumination fixture, the same group information as the second illumination fixture. More specifically, the same group information as the first group information “A” of the illumination fixture L2 which is identified as described above is assigned as the group information of the illumination fixture L1. Thereby, the illumination fixture L1 previously photographed is set to the group of the next photographed illumination fixture L2. In other words, the illumination fixture photographed the odd number of times is set to the same group as the illumination fixture photographed at the next even number of times.

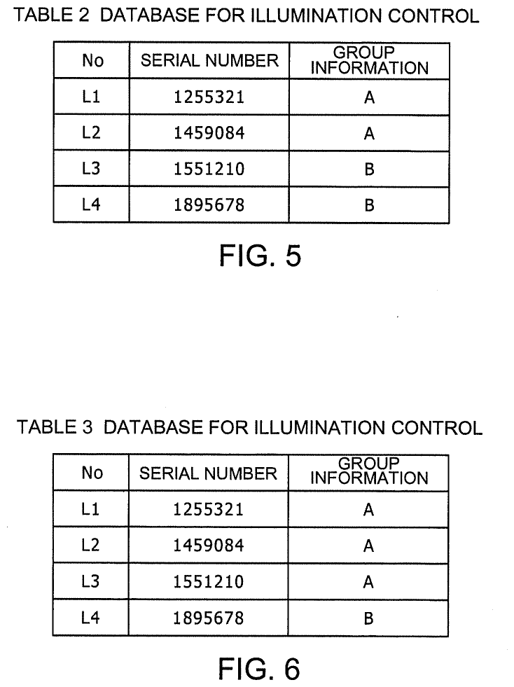

The group information thus set for the illumination fixtures L1 and L2 is transmitted from the communication part 50 of the smartphone 14 to the illumination control device 12 through the wireless LAN router 40, and is stored in the database 34 for illumination control of the illumination control device 12 in association with the serial numbers of the respective illumination fixtures L1 and L2. More specifically, as shown in FIG. 5, in the database 34 for illumination control, the first group information “A” is set as the group information for the illumination fixtures L1 and L2.

Subsequently, the user can also set the remaining illumination fixtures L3 and L4 of the four illumination fixtures L1 to L4 to respective groups, similarly. More specifically, the user photographs an image of the illumination fixture L3 to be next set to a group with the camera part 54 of the smartphone 14, and subsequently photographs an image of the illumination fixture L4 to be set as a group destination (that is, the user wishes to register as the same group) with the camera part 54 of the smartphone 14.

In this case, since the group information of the illumination fixture L4 photographed at a fourth time (i.e., at an even number of times) has not been set yet, the control part 52 assigns second group information “B” as unused group information to the illumination fixture L4. The control part 52 sets the same second group information “B” as the illumination fixture L4 thus identified as the group information of the illumination fixture L3 photographed at the previous third time (i.e., at the odd number of times).

Subsequently, as shown in FIG. 5, the control part 52 causes the second group information “B” of the illumination fixtures L3 and L4 that is identified as described above to be stored in the database 34 for illumination control of the illumination control device 12. Furthermore, the control part 52 may also store the correspondence table similar to that shown in FIG. 5 in its own storage.

As described above, the initial grouping of the illumination fixtures L1 to L4 can be performed (i.e., initial group setting). Note that the initial group setting for the plurality of illumination fixtures L1, L2, . . . , and Ln is not limited thereto, and may be performed in another procedure. For example, the user may successively photograph two or more illumination fixtures to be set to the same group, and set the same group information by manual input.

FIG. 6 is a table showing another example in which group information is assigned to each of the illumination fixtures in a correspondence table shown in FIG. 2. In this example, the illumination fixtures L1, L2, and L3 are set to a group A, and the illumination fixture L4 is set to a group B.

The initial group setting for the illumination fixtures L1 to L4 as shown in FIG. 6 can be performed as follows. That is, the group setting for the illumination fixtures L1 and L2 is performed in the same manner as described above, with reference to FIG. 3 to FIG. 5.

Subsequently, the user photographs an image of the illumination fixture L3 as the third photography operation, and photographs an image of the illumination fixture L1 or L2 as the subsequent fourth photography operation. In this case, since the first group information “A” has already been set for the illumination fixtures L1 and L2 by the first and second photography operations, the control part 52 assigns and sets the first group information “A” of the illumination fixture L1 or L2 photographed at the fourth time as the group information of the illumination fixture L3 photographed at the third time. Thereby, the illumination fixtures L1 to L3 are set to the same group A.

Subsequently, the user photographs an image of the illumination fixture L4 as the fifth photography operation, and photographs the same image of the illumination fixture L4 as the sixth photography operation again. Thus, by photographing the same illumination fixture L4 at the odd number of times and the even number of times, only one illumination fixture L4 is set to the group B in accordance with the group setting processes illustrated in FIG. 3.

In this manner, as shown in FIG. 6, the illumination fixtures L1 to L3 are set to the group A, only the illumination fixture L4 is set to the group B, and such group information is stored in the database 34 for illumination control.

As described above, the group setting method in the illumination system 10 of the present embodiment is a method of setting each of the plurality of illumination fixtures L1, L2, . . . , and Ln to a group, the plurality of illumination fixtures L1, L2, . . . , and Ln each having a light output pattern including its own unique identification information. In this group setting method, the camera part 54 of the smartphone 14 photographs the first illumination fixture of the plurality of the illumination fixtures, and identifies the identification information of the first illumination fixture based on the light output pattern. Subsequently, the terminal device photographs the second illumination fixture of the plurality of illumination fixtures, and identifies the identification information of the second illumination fixture based on the light output pattern, and the group information of the second illumination fixture. The terminal device sets, to the first illumination fixture, the same group information as the second illumination fixture. According to this group setting method and the illumination system 10 implementing this method, each of the plurality of illumination fixtures L1, L2, . . . , and Ln can be easily set to a group even by general users (for example, a resident of a house, or the like) that have no expert knowledge.

In this case, the smartphone 14 photographs the third illumination fixture of the plurality of the illumination fixtures, and identifies the identification information of the third illumination fixture based on the light output pattern. Subsequently, the smartphone 14 photographs the first or second illumination fixture, and identifies the group information of the first or second illumination fixture based on the light output pattern, and sets, to the third illumination fixture, the same group information as the first or second illumination fixture. Accordingly, the third illumination fixture can be set to the same group as the group to which the first or second illumination fixture is previously set, and each of the plurality of illumination fixtures L1, L2, . . . , and Ln can be easily set to a group even by general users that have no expert knowledge.

According to the group setting method for the illumination fixture of the present embodiment and the illumination system 10 implementing this method, the first illumination fixture may be the same as the second illumination fixture. Accordingly, when each of the plurality of illumination fixtures L1, L2, . . . , and Ln is set to a group, the group including only one illumination fixture can be easily set even by general users that have no expert knowledge.

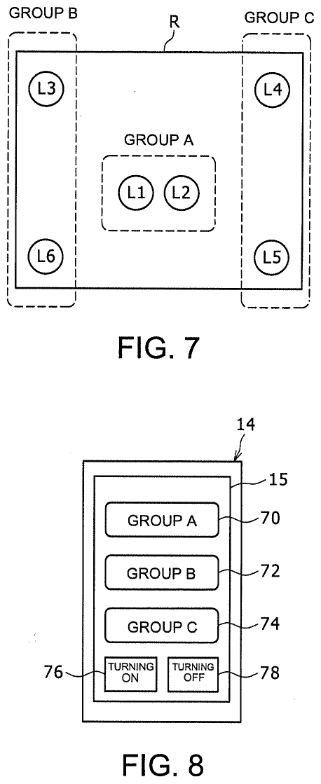

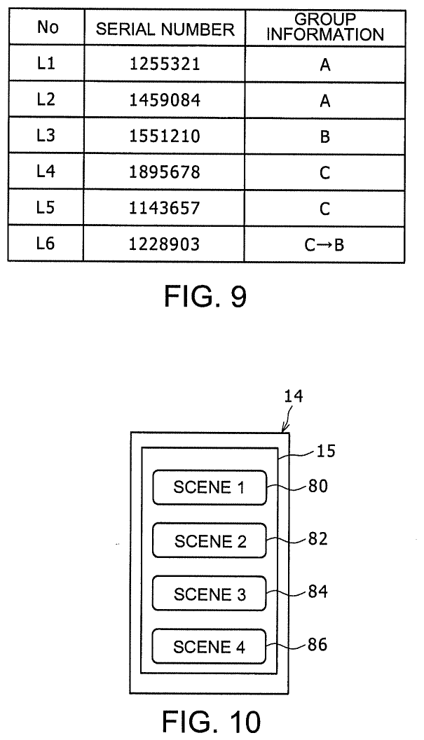

Next, the setting change of a group of the illumination fixtures will be described with reference to FIG. 7 to FIG. 10. FIG. 7 is a schematic diagram illustrating a room R in which six illumination fixtures L1 to L6 are set in three groups A, B, and C. FIG. 8 is a diagram illustrating an operation screen in each group displayed on the smartphone 14. FIG. 9 is a table showing an example of the database 34 for illumination control in which the six illumination fixtures L1 to L6 are set to the three groups A, B, and C as illustrated in FIG. 7.

In an example illustrated in FIG. 7, the six illumination fixtures L1 to L6 are installed on a ceiling of one room R. The two illumination fixtures L1 and L2 are arranged side by side in a center region of the rectangular ceiling, as viewed from above, and are set to the same group A. The illumination fixtures L3 and L6 are arranged at two corners, respectively, the two corners being positioned on one side in a long-side direction of the rectangular ceiling, and are set to the same group B. Furthermore, the illumination fixtures L4 and L5 are arranged at two corners, respectively, the two corners being positioned on the other side in the long-side direction of the rectangular ceiling, and are set to the same group C. The above-described group setting method can be used for the group setting for these six illumination fixtures L1 to L6, with reference to FIGS. 3 to 5.

The user can perform the lighting operations of the illumination fixtures L1 to L6 for each group using the smartphone 14. The operation screen illustrated in FIG. 8 can be displayed on the display part 15 of the smartphone 14 on which the illumination control application is installed. On this operation screen, an operation button 70 for the group A, an operation button 72 for the group B, an operation button 74 for the group C, a turning-on button 76, and a turning-off button 78 are displayed.

When the user taps on and selects one or more of the operation buttons 70, 72 and 74 to be turned on and then taps on the turning-on button 76, the illumination fixtures corresponding to the selected groups are turned on. More specifically, for example, when the user selects the operation button 70 for the group A, and then taps on the turning-on button 76, a command signal for turning on the group A is transmitted from the smartphone 14 to the illumination control device 12 through the wireless LAN router 40. The illumination control device 12 that has received this signal transmits a control signal including the serial numbers and the turning-on command for illumination fixtures L1 and L2 to each of the illumination fixtures L1 to L6. Thus, since the control part 22 of each of the illumination fixtures L1 and L2 causes the light source 24 to perform the light emitting operation (i.e., to be turned on) in accordance with the control signal including its own serial number. On the other hand, since the control signal does not include the serial numbers of the other illumination fixtures L3 to L6, the illumination fixtures L3 to L6 are held in the turned-off state (or the turned-on state).

When the user taps on the turning-off button 78 after selecting the operation button 70 for the group A, a command signal for turning off the group A is transmitted from the smartphone 14 to the illumination control device 12 through the wireless LAN router 40. The illumination control device 12 that has received this signal transmits a control signal including the serial numbers and the turning-off command for illumination fixtures L1 and L2 to each of the illumination fixtures L1 to L6. Thus, since the control part 22 of each of the illumination fixtures L1 and L2 causes the light source 24 to perform the turning-off operation in accordance with the control signal including its own serial number. On the other hand, since the control signal does not include the serial numbers of the other illumination fixtures L3 to L6, the illumination fixtures L3 to L6 are held in the turned-on state (or the turned-off state).

Note that since the same applies to the turning-on operation and the turning-off operation of the other groups B and C, the description will be omitted.

Thus, although the turning-on operation and the turning-off operation of the illumination fixtures L1 to L6 can be controlled in groups using the operation screen illustrated in FIG. 8, an example in which the user changes the group setting for the illumination fixtures L1 to L6 will be described. It is assumed, regarding the illumination fixtures L1 to L6, that the illumination fixtures L1 and L2 are set to the group A, the illumination fixture L3 is set to the group B, and the illumination fixtures L4, L5, and L6 are set to the group C as shown in FIG. 9. In this case, the illumination fixture L6 should have been set to the group B as illustrated in FIG. 7, but is erroneously set to the group C.

Then, the user can change the group setting for the illumination fixture L6 using the smartphone 14 on which the illumination control application is installed. Although the detailed description will be omitted, the group setting for the illumination fixture L6 can be changed in the same manner as the above-described group setting method, with reference to FIG. 3 to FIG. 5. That is, the user photographs an image of the illumination fixture L6 set to the group C as the first photography operation, and then photographs an image of the illumination fixture L3 as the second photography operation, the illumination fixture L3 being set to the group destination to which the illumination fixture L6 is to be set. Thereby, the control part 52 resets the group information of the illumination fixture L6 to the group information “B” that is the same as that of the illumination fixture L3. Thereby, the group setting for the illumination fixture L6 is changed to the group B. According to the group setting method for the illumination fixture of the present embodiment and the illumination system 10 implementing this method, the group setting for each of the plurality of illumination fixtures L1, L2, . . . , and Ln can be easily changed even by general users (for example, a resident of a house, or the like) that have no expert knowledge.

FIG. 10 is a diagram illustrating an operation screen in each scene displayed on the smartphone 14. In the illumination system 10 of the present embodiment, the illumination fixtures L1 to L6 set to the respective groups can be set to respective scenes to perform the turning-on operation or the turning-off operation. On the operation screen in each scene, an operation button 80 for a scene 1, an operation button 82 for a scene 2, an operation button 84 for a scene 3, and an operation button 86 for a scene 4 are displayed, as illustrated in FIG. 10.

For example, a “full turning-on” mode for turning on all of the illumination fixtures L1 to L6 set to the groups A, B, and C can be set as the scene 1, a “first relaxation” mode for turning on only the illumination fixtures L1 and L2 set to the group A can be set as the scene 2, and a “second relaxation” mode for turning on the illumination fixtures L3 to L6 set to the groups B and C can be set as the scene 3. Each scene number can be stored in the database 34 for illumination control of the illumination control device 12 in association with the group information.

Note that the group setting method for the illumination fixture and the illumination system according to the present disclosure are not limited to the above-described embodiments and the modified examples. Various modifications or improvements can be made within the scope of matters set forth in the claims of the present application. While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A group setting method to set each of a plurality of illumination fixtures as a group, the plurality of illumination fixtures each having a light output pattern including its own unique identification information, the method comprising:
photographing a first illumination fixture of the plurality of illumination fixtures with a terminal device having an imaging part, and identifying identification information of the first illumination fixture based on a light output pattern of the first illumination fixture;
subsequently, photographing a second illumination fixture of the plurality of illumination fixtures with the terminal device, identifying identification information of the second illumination fixture based on a light output pattern of the second illumination fixture, and identifying first group information of the second illumination fixture; and
setting the first group information identified for the second illumination fixture to the first illumination fixture.

2. The group setting method for an illumination fixture according to claim 1, further comprising:
subsequent to setting of the first group information to the first illumination fixture, photographing a third illumination fixture of the plurality of the illumination fixtures with the terminal device, and identifying identification information of the third illumination fixture based on the light output pattern of the third illumination fixture; and
subsequently, photographing the first or second illumination fixture with the terminal device to identify the group information of the first or second illumination fixture based on the light output pattern of the first or second illumination fixture, and setting the first group information identified for the first or second illumination fixture to the third illumination fixture.

3. The group setting method for an illumination fixture according to claim 2, further comprising:
subsequent to setting of the first group information to the third illumination fixture, photographing a fourth illumination fixture of the plurality of the illumination fixtures with the terminal device, and identifying identification information of the fourth illumination fixture based on the light output pattern of the fourth illumination fixture; and
subsequently, photographing the fourth illumination fixture with the terminal device again, and setting second group information that is different from the first group information to the fourth illumination fixture.

4. The group setting method for an illumination fixture according to claim 1, further comprising:
subsequent to setting of the first group information to the first illumination fixture, photographing a third illumination fixture of the plurality of the illumination fixtures with the terminal device, and identifying identification information of the third illumination fixture based on the light output pattern of the third illumination fixture; and
subsequently, photographing a fourth illumination fixture of the plurality of illumination fixtures with the terminal device, identifying identification information of the fourth illumination fixture based on a light output pattern of the fourth illumination fixture, and identifying second group information of the fourth illumination fixture; and
setting the second group information identified for the fourth illumination fixture to the third illumination fixture.

5. The group setting method for an illumination fixture according to claim 1, wherein
the first illumination fixture and the second illumination fixture are a single illumination fixture.

6. An illumination system, comprising:
a plurality of illumination fixtures each having a light output pattern including its own unique identification information;
an illumination control device including a database storing group information in association with the plurality of illumination fixtures; and
a terminal device having an imaging part, and configured to identify identification information of an illumination fixture based on a light output pattern of the illumination fixture photographed by the imaging part and cause group information to be stored in the database in association with the identification information of the illumination fixture,
wherein the terminal device identifies the identification information of a first illumination fixture based on a light output pattern of the first illumination fixture when photographing the first illumination fixture of the plurality of illumination fixtures,
subsequently identifies the identification information of a second illumination fixture based on the light output pattern of the second illumination fixture when photographing the second illumination fixture of the plurality of illumination fixtures, and identifies first group information of the second illumination fixture, and
causes the first group information identified for the second illumination fixture to be stored in the database in association with the first illumination fixture.

7. The illumination system according to claim 6, wherein
subsequent to causing the first group information to be stored in the database in association with the first illumination fixture, the terminal device identifies the identification information of a third illumination fixture based on a light output pattern of the third illumination fixture when photographing the third illumination fixture of the plurality of illumination fixtures, subsequently identifies the first group information of the first or second illumination fixture based on the light output pattern of the first or second illumination fixture when photographing the first or second illumination fixture, and
causes the first group information identified for the first or second illumination fixture to be stored in the database in association with the third illumination fixture.

8. The illumination system according to claim 7, wherein
subsequent to causing the first group information to be stored in the database in association with the third illumination fixture, the terminal device identifies the identification information of a fourth illumination fixture based on a light output pattern of the fourth illumination fixture when photographing the fourth illumination fixture of the plurality of illumination fixtures, and subsequently causes second group information that is different from the first group information to be stored in the database in association with the fourth illumination fixture when photographing the fourth illumination fixture again.

9. The illumination system according to claim 6, wherein
subsequent to causing the first group information to be stored in the database in association with the first illumination fixture, the terminal device identifies the identification information of a third illumination fixture based on a light output pattern of the third illumination fixture when photographing the third illumination fixture of the plurality of illumination fixtures; subsequently identifies the identification information of a fourth illumination fixture based on the light output pattern of the fourth illumination fixture when photographing the fourth illumination fixture of the plurality of illumination fixtures, and identifies second group information of the fourth illumination fixture, and
causes the second group information identified for the fourth illumination fixture to be stored in the database in association with the third illumination fixture.

10. The illumination system according to claim 6, wherein
the first illumination fixture and the second illumination fixture are a single illumination fixture.
